(19) United States
(12) Patent Application Publication
(10) Pub. No.: US 2005/0004275 A1
(43) Pub. Date: Jan. 6, 2005

(54) Stabilising composition II

(76) Inventors: Thomas Heidenfelder, Dannstadt (DE); Manfred Appel, Landau (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/496,311

(22) PCT Filed: Dec. 13, 2002
(86) PCT No.: PCT/EP02/14236

(30) Foreign Application Priority Data
Dec. 14, 2001 (DE) 101 61 863.8

(51) Int. Cl. C09K 15/00; C08K 5/34; C08K 5/48; C08K 5/15

(52) U.S. Cl. 524/86; 252/397; 524/107

(57) ABSTRACT

A stabilizer composition is described and comprises a 3-arylacrylate, a sterically hindered monomeric amine, a sterically hindered phenol, a chromane derivative, and an organic phosphite and/or phosphonite. The stabilizer composition is particularly suitable for stabilizing thermoplastic polyurethane with respect to light, oxygen, and heat.

The present invention relates to a stabilizer composition and also to its use for stabilizing non-living organic material with respect to exposure to light, oxygen, and heat.

The mechanical, chemical, and/or esthetic properties of non-living organic material, in particular plastics and paints, are known to be impaired by exposure to light, oxygen, and heat. This impairment is usually apparent in the form of yellowing, discoloration, cracking, or embrittlement of the material. Stabilizers or stabilizer compositions are intended to give satisfactory protection from impairment of organic material by light, oxygen, and heat.

EP 0 791 032 discloses the use of certain 3-arylacrylates as stabilizers, including light stabilizers, for non-living organic material. The 3-arylacrylates may be used in combination with sterically hindered amines or with sterically hindered phenols.

EP 0 263 524 relates to a stabilizer mixture made from chromane derivatives and from organic phosphites or phosphonites for stabilizing plastics, and this stabilizer mixture may, where appropriate, also comprise other stabilizers.

DE-A-4405670 relates to a stabilizer mixture made from chromane derivatives and from organic phosphites or phosphonites, and from amines, for stabilizing organic material.

DE 199 48 117 discloses a stabilizer composition which comprises a 3-arylacrylate, a sterically hindered amine, a chromane derivative, and an organic phosphite and/or phosphonite.

An unsatisfactory factor with these stabilizer compositions is often the low duration of protective action.

It is an object of the present invention to provide a stabilizer composition which provides long lasting protective action at a high level, in particular with regard to gloss retention, with respect to exposure to light, oxygen, and heat. The stabilizer composition is intended to be particularly effective in stabilizing polyurethanes.

We have found that this object is achieved by way of a stabilizer composition which comprises

A) at least one 3-arylacrylate of the formula I 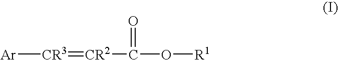
where
Ar is an aryl radical which may also bear 1, 2 or 3 substituents selected from the group consisting of C₁-C₄-alkyl, C₁-C₄-alkoxy, hydroxy, phenoxy, amino, mono- or di(C₁-C₄-alkyl)amino, halogen, or nitro, or may bear a methylenedioxy group,
R¹ is C₁-C₂₀-alkyl, C₂-C₂₀-alkenyl, or C₃-C₈-cycloalkyl, where appropriate substituted by up to three radicals selected from the class consisting of halogen, cyano, nitro, amino, C₁-C₄-alkylamino, C₁-C₄-dialkylamino, hydroxy, C₁-C₄-alkyl, and C₁-C₄-alkoxy, and
R² and R³ are hydrogen or C₁-C₄-alkyl,

B) at least one amine of the formula II 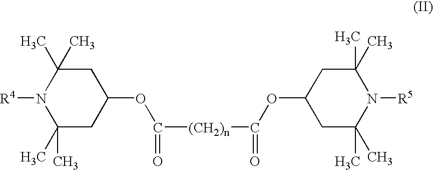
where
R⁴ and R⁵, independently of one another, are hydrogen, C₁-C₄-alkyl, or C₁-C₁₂-alkoxy, and
n is an integer from 2 to 10,

C) at least one phenol of the formula III 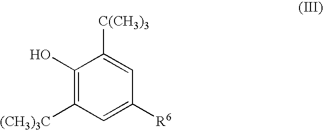
where
R⁶ is C₁-C₂₀-alkoxycarbonyl-C₁-C₆-alkyl,

D) at least one chromane derivative of the formula IV 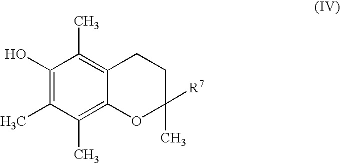
where R⁷ is a group of the formula 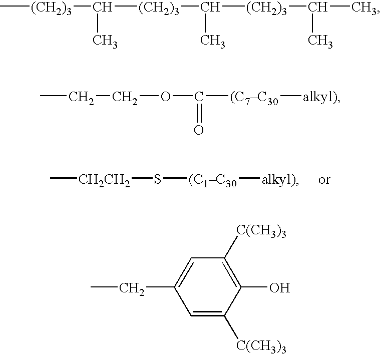
and

E) at least one organic phosphite and/or phosphonite.

At room temperature, the stabilizer composition of the invention is generally a viscous liquid, and its incorporation into the material to be stabilized, and its homogeneous distribution therein, are therefore easy.

It has also been found that the protective action of the stabilizer composition of the invention with respect to exposure to light, oxygen, and heat is higher than would be expected from the contributions of the components of the stabilizer composition. The well-developed protective action provided by the stabilizer composition of the invention is therefore based on a synergistic effect of the components.

As component A), the stabilizer composition of the invention encompasses a 3-arylacrylate of the formula I 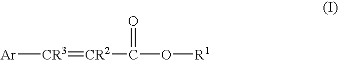
Examples of Ar in Formula I are
phenyl,
o-, m- or p-tolyl,
o-, m- or p-ethylphenyl,
o-, m- or p-propylphenyl,
m- or p-cumyl,
o-, m- or p-butylphenyl,
m- or p-isobutylphenyl,
m- or p-sec-butylphenyl,
m- or p-tert-butylphenyl,
2,3-, 2,4-, 2,5-, 2,6-, 3,4- or 3,5-dimethylphenyl,
mesityl,
o-, m- or p-methoxyphenyl,
o-, m- or p-ethoxyphenyl,
o-, m- or p-propoxyphenyl,
m- or p-isopropoxyphenyl,
o-, m- or p-butoxyphenyl,
m- or p-isobutoxyphenyl,
m- or p-sec-butoxyphenyl,
m- or p-tert-butoxyphenyl,
2,3-, 2,4-, 2,5-, 2,6-, 3,4- or 3,5-dimethoxyphenyl,
o-, m- or p-hydroxyphenyl,
2,3-, 2,4-, 2,5-, 2,6-, 3,4- or 3,5-dihydroxyphenyl,
3-hydroxy-4-methoxyphenyl,
m- or p-phenoxyphenyl,
o-, m- or p-aminophenyl,
o-, m- or p-(N-methylamino)phenyl,
o-, m- or p-(N,N-dimethylamino)phenyl,
o-, m- or p-fluorophenyl,
o-, m- or p-chlorophenyl,
2,4-dichlorophenyl,
o-, m- or p-bromophenyl,
o-, m- or p-nitrophenyl,
2,3- or 3,4-methylenedioxyphenyl,
2-, 3- or 4-biphenyl, and
α- or β-naphthyl.

Particular preference is given to C₁-C₄-alkoxyphenyl radicals, in particular those where the position of the alkoxy radical on the phenyl core is para.

R¹ is a straight-chain or branched C₁-C₂₀-alkyl group, e.g. methyl, ethyl, n-propyl, isopropyl, n-butyl, isobutyl, sec-butyl, tert-butyl, n-pentyl, isopentyl, sec-pentyl, tert-pentyl, neo-pentyl, n-hexyl, n-heptyl, n-octyl, 2-ethylhexyl, n-nonyl, isononyl, n-decyl, n-undecyl, n-dodecyl, n-tridecyl, isotridecyl, n-tetradecyl, n-hexadecyl, n-octadecyl, n-eicosyl; or a straight-chain or branched C₂-C₂₀-alkylene group, e.g. vinyl, allyl, methallyl, oleyl, linolyl or linolenyl; or a C₃-C₈-cycloalkyl group, such as cyclopropyl, cyclobutyl, cyclopentyl, cyclohexyl, cycloheptyl or cyclooctyl. Among these, preference is given to-straight-chain or branched C₅-C₁₆-alkyl groups, in particular straight-chain or branched C₈-C₁₂-alkyl groups. Of particular interest are straight-chain or branched C₈-alkyl groups. Among the cycloalkyl groups, preference is given to cyclopentyl and cyclohexyl.

The groups mentioned may have substitution by up to three radicals selected from the group consisting of halogen, cyano, nitro, amino, C₁-C₄-alkylamino, C₁-C₄-dialkylamino, hydroxy, C₁-C₄-alkyl, and C₁-C₄-alkoxy.

Examples of Halogen are Fluorine, Chlorine, and Bromine.

The radicals R² and R³, independently of one another, are in particular hydrogen, methyl, or ethyl. It is very particularly preferable that in the formula I R² is hydrogen or methyl and R³ id hydrogen.

2-Ethylhexyl p-methoxycinnamate is particularly preferred as 3-arylacrylate of the formula I.

As component B), the stabilizer composition of the invention comprises at least one sterically hindered monomeric amine of the formula II 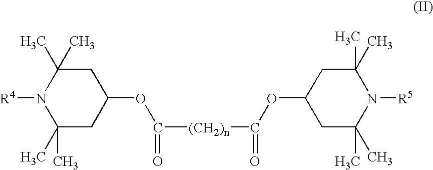
where
R⁴ and R⁵, independently of one another, are hydrogen, C₁-C₄-alkyl or C₁-C₁₂-alkoxy, and
n is an integer from 2 to 10, preferably 2 to 8, in particular 8.

Each of R⁴ and R⁵, independently of the other, is hydrogen, a straight-chain or branched C₁-C₄-alkyl group, e.g. methyl, ethyl, n-propyl, isopropyl, n-butyl, isobutyl, sec-butyl, tert-butyl, or a straight-chain or branched C₁-C₁₂-alkoxy group, such as methoxy, ethoxy, n-propoxy, isopropoxy, n-butoxy, isobutoxy, sec-butoxy, tert-butoxy, n-pentyloxy, n-hexyloxy, iso-hexyloxy, n-octyloxy, 2-ethylhexyloxy, iso-octyloxy, n-nonyloxy, n-decyloxy, n-undecyloxy, or n-dodecyloxy. Particularly suitable groups among these are hydrogen, methyl, and the isomeric octyloxy groups.

The compounds which may be used as component B) may be liquid to crystalline. Particularly suitable compounds are bis-(1,2,2,6,6-pentamethylpiperidin-4-yl) sebacate, commercially available with the name Lowilite® 76 from the company Great Lakes, bis-(2,2,6,6-tetramethylpiperidin-4-yl) sebacate, commercially available with the name Lowilite® 77 from the company Great Lakes, bis-(2,2,6,6-tetramethylpiperidin-4-yl) succinate, commercially available with the name Tinuvin® 780 FF 35 from the company Ciba-Geigy, bis-(1-octyloxy-2,2,6,6-tetramethylpiperidin-4-yl) sebacate, commercially available with the name Tinuvin® 123 from the company Ciba-Geigy. It is preferable to use sterically hindered monomeric amines which at room temperature or below 100° C. are liquid, an example being bis-(1,2,2,6,6-penta-methylpiperidin-4-yl) sebacate.

As component C), the stabilizer composition of the invention comprises at least one phenol of the formula III 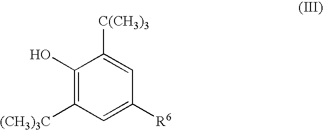
where
R⁶ is C₁-C₂₀-alkoxycarbonyl-C₁-C₆-alkyl, preferably C₁-C₂₀-alkoxycarbonyl-C₁-C₄-alkyl.

Particularly suitable compounds for this purpose are (3,5-di-tert-butyl-4-hydroxyphenyl)propionates of C₁-C₂₀-alkanols, for example isooctyl 3-(3,5-di-tert-butyl-4-hydroxyphenyl)propionate, commercially available with the name Irganox® 1135 from the company Ciba-Geigy, or n-octadecyl 3-(3,5-di-tert-butyl-4-hydroxyphenyl)-propionate, commercially available with the name Irganox® 1076 from the company Ciba-Geigy.

As component D), the stabilizer composition of the invention comprises at least one chromane derivative of the formula IV 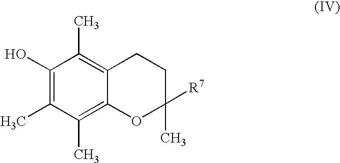
where R⁷ is a group of the formula

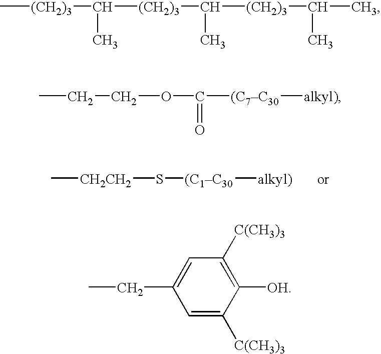

Particularly suitable compounds for this purpose are 2,5,7,8-tetramethyl-2-(2′-stearoyloxyethyl)chromane (R⁷=—CH₂CH₂—O—CO—C₁₇H₃₅), and in particular α-tocopherols, preferably D,L-α-tocopherol (R⁷=—(CH₂)₃—CH(CH₃)—(CH₂)₃—CH(CH₃)—(CH₂)₃—C(CH₃)₂).

As component E), the stabilizer composition of the invention comprises at least one organic phosphite and/or phosphonite.

Particularly suitable compounds for this purpose are organic phosphites of the formula V 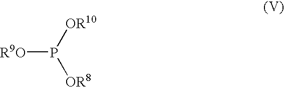
where each of the radicals R⁸ to R¹⁰ is C₂-C₁₂-alkyl, preferably C₆-C₁₁-alkyl, in particular C₈-C₁₀-alkyl, or C₆-C₁₈-aryl, preferably phenyl, which may have substitution by C₁-C₁₈-alkyl groups, preferably by from one to three C₄-C₁₂-alkyl groups,
or an organic phosphonite of the formula VI 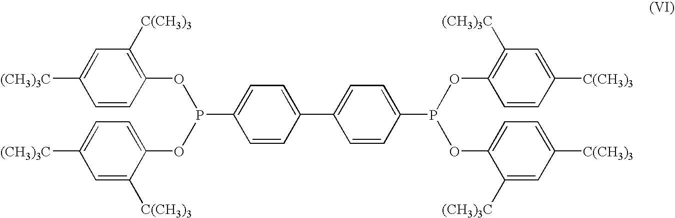
or a mixture made from the phosphites V and the phosphonite VI.

The phosphites and phosphonites which may be used according to the invention may be either liquid or crystalline. Examples which may be mentioned of phosphites of the formula V are:
trialkyl phosphites having preferably long-chain linear or branched alkyl groups, such as octyl, nonyl, isononyl, decyl or isodecyl groups; preferably tris(nonylphenyl) phosphite;
triarylphosphites having unsubstituted aryl groups or having aryl groups mono- to trisubstituted by alkyl, examples being phenyl, nonylphenyl, or 2,4-di-tert-butylphenyl groups;
mixed aryl alkyl phosphites, such as diisodecyl phenyl phosphite or diphenyl pentaerythritol diphosphite.

The phosphonite of the formula VI is available commercially with the name Irgafos® P-EPQ from the company Ciba-Geigy.

The stabilizer composition of the invention also optionally comprises at least one other light stabilizer which absorbs radiated light in the UV-A (320-400 nm) and/or UV-B (280-320 nm) region. Of course, the additional light stabilizers have to be compatible with the stabilizer composition, and preferably colorless in the visible region. Examples which may be mentioned of UV absorbers of this type are: 2-hydroxybenzophenones, 2-hydroxyphenylbenzotriazoles, oxanilides, 2-hydroxyphenyl-triazines, 4,4′-diarylbutadienes.

Examples of suitable 2-hydroxybenzophenones, of which a wide variety is commercially available, are: 2-hydroxy-4-methoxy-benzophenone, 2,4-dihydroxybenzophenone, 2-hydroxy-4-dodecoxy-benzophenone, 2,2′-dihydroxy-4-methoxybenzophenone (trade name Cyasorb® UV 24, American Cyanamid), 2,2′-dihydroxy-4,4′-di-methoxybenzophenone, 2,2′,4,4′-tetrahydroxybenzophenone. The 2-hydroxybenzophenones feature good UV resistance and high absorptive power.

Examples of suitable 2-hydroxyphenylbenzotriazoles are 2-(2′-hydroxy-5′-methylphenyl)benzotriazole (trade name Tinuvin® P, Ciba-Geigy), 2-(2′-hydroxy-5′-tert-octylphenyl)-benzotriazole (trade name Cyasorb® UV 5411), 2-(2′-hydroxy-3′-tert-butyl-5′-methylphenyl)benzotriazole (trade name Tinuvin® 326, Ciba-Geigy), 2-(2′-hydroxy-3′,5′-di-tert-butylphenyl)-5-chlorobenzotriazole (trade name Tinuvin® 327, Ciba-Geigy). 2-Hydroxyphenylbenzotriazoles absorb at the limit of the visible region and do not exhibit any yellow coloration.

An example of a suitable 2-hydroxyphenyltriazine is 2,4-bis-(2′, 2″,4′,4″-tetramethylphenyl)-6-(2′″-hydroxy-4′″-octyloxy-phenyl)-1,3,5-triazine (trade name Cyasorb® 1164, American Cyanamid).
Examples of Preferred Oxanilides are:

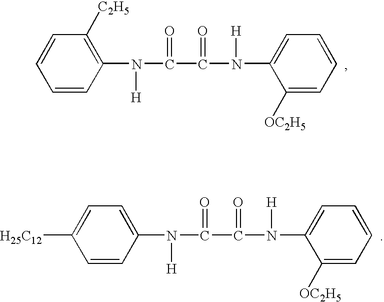

4,4′-Diarylbutadienes of the Formula VII 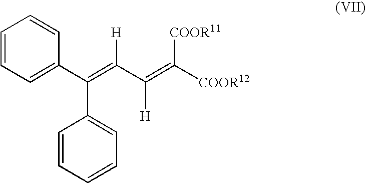
are known from EPA 916 335. The substituents R¹¹ and/or R¹² are preferably C₁-C₈-alkyl and C₅-C₈-cycloalkyl.

The stabilizer composition of the invention generally comprises
from 35 to 65 parts by weight, preferably from 37 to 60 parts by weight, of A),
from 10 to 50 parts by weight, preferably from 15 to 45 parts by weight, of B),
from 5 to 15 parts by weight, preferably from 7 to 12 parts by weight, of C),
from 0.5 to 2.5 parts by weight, preferably from 0.7 to 2.0 parts by weight, of D) and
from 5 to 25 parts by weight, preferably from 7 to 20 parts by weight, of E).

If concommitant use is made of another light stabilizer, its amount used is preferably from 0.1 to 15 parts by weight, preferably from 1 to 12 parts by weight, based on the total weight of the stabilizer composition.

The concentration of the stabilizer composition of the invention added to the organic material to be stabilized, prior to, during, or after its preparation, is generally from 0.01 to 5% by weight, preferably from 0.01 to 2% by weight, in particular from 0.05 to 1% by weight, based on the organic material.

Examples of non-living organic material are cosmetic preparations, such as ointments and lotions, pharmaceutical formulations, such as pills and suppositories, photographic recording materials, in particular photographic emulsions, precursors of plastics and paints, and in particular the actual paints and plastics themselves.

Examples which may be mentioned of plastics which can be stabilized by the stabilizer mixture of the invention are:
polymers of mono- or diolefins, e.g. low- or high-density polyethylene, and polypropylene, linear poly-1-butene, polyisoprene, polybutadiene, and also copolymers of mono- or diolefins, and mixtures of the polymers mentioned;
polystyrene, and also copolymers of styrene or α-methylstyrene with dienes and/or with acrylic derivatives, e.g. styrene-butadiene, styrene-acrylonitrile (SAN), styrene-ethyl methacrylate, styrene-butadiene-ethyl acrylate, styrene-acrylonitrile-methacrylate, acrylonitrile-butadiene-styrene (ABS), and methyl methacrylate-butadiene-styrene (MBS);
halogen-containing polymers, e.g. polyvinyl chloride, polyvinyl fluoride, polyvinylidene fluoride and also copolymers of these;
polymers which derive from α,β-unsaturated acids or from derivatives of these, for example polyacrylates, polymethacrylates, polyacrylamides, and polyacrylonitriles;
polymers which derive from unsaturated alcohols and amines or from their acid derivatives or acetals, e.g. polyvinyl alcohol and polyvinyl acetate;
polyurethanes, polyamides, polyureas, polyphenylene ethers, polyesters, polycarbonates, polysulfones, polyether sulfones, and polyether ketones.

The paints which may be stabilized using the stabilizer composition of the invention include paints such as alkyd resin paints, emulsion paints, epoxy resin paints, polyurethane paints, acrylic resin paints, cellulose nitrate paints, and varnishes, such as wood-protection varnishes.

The stabilizer composition of the invention is particularly suitable for stabilizing polyurethanes, in particular thermoplastic polyurethanes. These are mainly linear polyurethanes which are obtained from diisocyanates, such as 4,4′-diisocyanatodiphenylmethane, and from long-chain diols, such as polytetrahydrofuran or polyester polyols. The starting material used is generally appropriate prepolymers, and short-chain diols or diamines are used as chain extenders. The resultant products have a segmented structure, examples of molecular weights of the soft segments being from 1 000 to 3 000, these being crosslinked physically by the hard segments.

The stabilizer composition of the invention may also be prepared in the form of a masterbatch, for example one which comprises a concentration of from 2.5 to 25% by weight of the composition, the masterbatch being added to the materials to be stabilized.

The materials stabilized using the stabilizer composition of the invention exhibit particular quality features with regard to color change and gloss retention when compared with materials stabilized with the comparative composition, i.e. their impairment by external effects is delayed. There should be a maximum of retention of gloss and color during entire service life, and loss of these always means loss of quality. The materials stabilized according to the invention therefore feature a prolonged service time.

The examples below give further illustration of the invention.

### I. Description of Test Methods

1. Determination of Gardner Gloss Level

Gloss is measured using a Gardner Micro-Gloss 600 reflectometer to DIN 67530.

2. Determination of Color Difference

Prior to and after weathering, the CIELAB color differences ΔE were calculated for each specimen from the tristimulus values with the aid of the color difference formula. The CIE tristimulus values X, Y, and Z were determined for the specimens using the DataColor color-measurement device from Datacolor.

### II. EXAMPLES

### Example 1

A stabilizer composition 1 was prepared from:
54 parts by weight of 2-ethylhexyl p-methoxycinnamate,
18 parts by weight of bis-(1,2,2,6,6-pentamethyl-piperidin-4-yl) sebacate,
10 parts by weight of isooctyl 3-(3,5-di-tert-butyl-4-hydroxyphenyl)propionate, and
18 parts by weight of a mixture made from 1 part by weight of α-tocopherol and 10 parts by weight of tris(nonylphenyl) phosphite.

### Example 2

A stabilizer composition 2 was prepared from:
40 parts by weight of 2-ethylhexyl p-methoxycinnamate,
40 parts by weight of bis-(1,2,2,6,6-pentamethyl-piperidin-4-yl) sebacate,
10 parts by weight of isooctyl 3-(3,5-di-tert-butyl-4-hydroxyphenyl)propionate, and
10 parts by weight of a mixture made from 1 part by weight of α-tocopherol and 10 parts by weight of tris(nonyl-phenyl) phosphite.

The comparison used was a commercially available stabilizer composition whose makeup was as follows:
60 parts by weight of 2-ethylhexyl p-methoxycinnamate, 20 parts by weight of bis(1,2,2,6,6-pentamethyl-piperidin-4-yl) sebacate, and
20 parts by weight of a mixture made from 1 part by weight of α-tocopherol and 10 parts by weight of tris(nonyl-phenyl) phosphite.

### III. Testing of Stabilizer Action

The stabilizer was added to a TPU reaction, and the samples here were produced by casting.

1% by weight of the stabilizer composition of example 1 was incorporated into one specimen, and 1% by weight of the stabilizer composition of example 2 was incorporated into another specimen. The comparison used was a specimen into which 1% by weight of the stabilizer composition of the comparative example has been incorporated. Since rapid yellowing occurred under the test conditions in the case of the unstabilized specimen, it was not possible to use the unstabilized specimen to carry out a control test.

Test specimens were weathered using a Weather-Ometer® accelerated weathering device from the company Atlas Materials Testing Technology B.V., the Netherlands. Gardner gloss (table 1) and color change (table 2) were determined as a function of weathering time. The results are given in tables 1 and 2 below.

TABLE 1
Gardner gloss as a function of time

| | 0 [h] | 500 [h] | 1000 [h] | 1500 [h] |
|---|---|---|---|---|
| Comparison | 27 | 38 | 40 | 30 |
| Example 1 | 26 | 25 | 35 | 40 |
| Example 2 | 38 | 58 | 58 | n.d. |

n.d. not determined

In relation to gloss level, the specimens stabilized with the stabilizer compositions of the invention exhibited particularly good gloss retention, and stabilizer composition 1 featured particularly long lasting action here.

TABLE 2
Color difference ΔE − CIE as a function of time

| | 200 [h] | 400 [h] | 600 [h] | 800 [h] | 1000 [h] |
|---|---|---|---|---|---|
| Comparison | 4.3 | 5.4 | 3.9 | 1.1 | 4.6 |
| Example 1 | 4.7 | 6.3 | 4.5 | 1.2 | 4.1 |
| Example 2 | 7.4 | 10.4 | 9.4 | 5.2 | 3.1 |

As can be seen from table 2, the specimens stabilized using the stabilizer compositions of the invention exhibited markedly less color change than the specimen stabilized using the comparative composition after weathering for 1000 hours.

1. A stabilizer composition comprising
A) from 35 to 65 parts by weight of at least one 3-arylacrylate of the formula I: 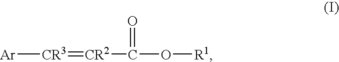
where
Ar is an aryl radical which may also bear 1, 2 or 3 substituents selected from the group consisting of C₁-C₄-alkyl, C₁-C₄-alkoxy, hydroxy, phenoxy, amino, mono-or di(C₁-C₄-alkyl)amino, halogen, or nitro, or may bear a methylenedioxy group,
R¹ is C₁-C₂₀-alkyl, C₂-C₂₀-alkenyl, or C₃-C₈-cycloalkyl, where appropriate substituted by up to three radicals selected from the class consisting of halogen, cyano, nitro, amino, C₁-C₄-alkylamino, C₁-C₄-dialkylamino, hydroxy, C₁-C₄-alkyl, and C₁-C₄-alkoxy, and
R² and R³ are hydrogen or C₁-C₄-alkyl,
B) from 10 to 50 parts by weight of at least one amine of the formula II: 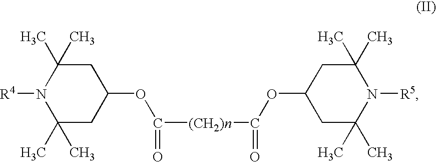
where
R⁴ and R⁵, independently of one another, are hydrogen, C₁-C₄-alkyl, or C₁-C₁₂-alkoxy, and
n is an integer from 2 to 10,
C) from 5 to 15 parts by weight of at least one phenol of the formula III: 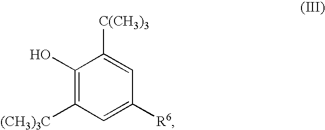
where
R⁶ is C₁-C₂₀-alkoxycarbonyl-C₁-C₆-alkyl,
D) from 0.5 to 2.5 parts by weight of at least one chromane derivative of the formula IV: 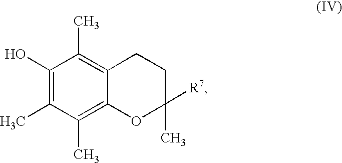
where R⁷ is selected from a group of the formula: 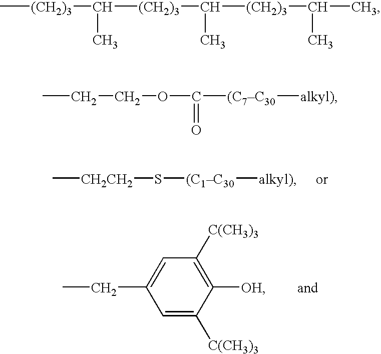
E) from 5 to 25 parts by weight of at least one organic phosphite and/or phosphonite.

2. The stabilizer composition as claimed in claim 1, wherein component A) is 2-ethylhexyl p-methoxycinnamate.

3. The stabilizer composition as claimed in claim 1 wherein component B) is bis-(1,2,2,6,6-pentamethylpiperidin-4-yl) sebacate.

4. The stabilizer composition as claimed in claim 1, wherein component C) is isooctyl 3-(3,5-di-tert-butyl-4-hydroxyphenyl)propionate.

5. The stabilizer composition as claimed in claim 1, wherein component D) is α-tocopherol.

6. The stabilizer composition as claimed in claim 1, where component E) is tris(nonylphenyl) phosphite.

7. A method for stabilizing non-living organic material with respect to exposure to light, oxygen, and heat, comprising adding the stabilizer composition of claim 1 to the non-living organic material.

8. The method as claimed in claim 7, wherein the non-living organic material comprises one or more for stabilizing plastics.

9. The method as claimed in claim 8, wherein the one or more plastics comprise one or more polyurethanes.

10. A thermoplastic molding composition comprising the stabilizer composition as claimed in claim 1.

11. The method as claimed in claim 9, wherein the one or more polyurethanes comprise one or more thermoplastic polyurethanes.
